(19) United States
(12) Patent Application Publication
(10) Pub. No.: US 2026/0023563 A1
(43) Pub. Date: Jan. 22, 2026

(54) MEMORY DEVICE, MEMORY SYSTEM, AND DATA FORMAT CONVERSION METHOD

(71) Applicant: Samsung Electronics Co., Ltd., Suwon-si (KR)

(72) Inventors: Ho Youn KIM, Suwon-si (KR); Jong Yoon YOON, Suwon-si (KR)

(21) Appl. No.: 19/055,099

(22) Filed: Feb. 17, 2025

(30) Foreign Application Priority Data
Jul. 16, 2024 (KR) 10-2024-0093855

(51) Int. Cl. G06F 9/30; G06F 13/16

(52) U.S. Cl. CPC G06F 9/30025; G06F 9/3001; G06F 13/1668

(57) ABSTRACT

A memory device comprises a control logic circuit configured to receive a format conversion command instructing conversion of first data having a first data type into second data having a second data type, and generate format information based on the format conversion command, and a format converter configured to receive the first data and generate the second data by converting the first data based on the format information, wherein the format converter is configured to: in response to the first and second data types being different, clip the first data according to a clipping range determined based on the format information, multiply the clipped first data by a scaling factor based on the format information, discard a fractional part of a result of the multiplication, and in response to the first and second data types being the same, discard some bits of the first data according to the format information.

### CROSS-REFERENCE TO RELATED APPLICATION

This application claims priority under 35 U.S.C. § 119 from Korean Patent Application No. 10-2024-0093855 filed on Jul. 16, 2024, in the Korean Intellectual Property Office, and all the benefits accruing therefrom under 35 U.S.C. § 119, the contents of which in its entirety are herein incorporated by reference.

### BACKGROUND

### 1. Field

The present disclosure relates to a memory device, a memory system, and a data format conversion method.

### 2. Description of the Related Art

With the development of technologies such as artificial intelligence (AI) and machine learning, there are cases where quantization or data format conversion is necessary to reduce the computational complexity when performing inference operations on auxiliary processors such as graphics processing units (GPUs) and neural processing units (NPUs). However, auxiliary processors like GPUs and NPUs, which are specialized in arithmetic operations, find it difficult to directly perform quantization and data format conversion. Therefore, when auxiliary processors read and write data to memories, such as dynamic random-access memories (DRAMs), they must go through the central processing unit (CPU) to perform quantization and data format conversion. This can cause data bottlenecks and impose a significant burden on the CPU, which is responsible for system management.

### SUMMARY

Aspects of the present disclosure provide a memory device that converts the format of data according to a command from a host device.

Aspects of the present disclosure also provide a memory system that converts the format of data according to a command from a host device.

Aspects of the present disclosure also provide a method for converting the format of data in a memory device according to a command from a host device.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, there is provided a memory device comprises a control logic circuit configured to receive a format conversion command that instructs conversion of first data having a first data type into second data having a second data type, and to generate format information based on the format conversion command, and a format converter configured to receive the first data and generate the second data by converting the first data based on the format information, wherein in response to the first and second data types being different, the format converter is further configured to: clip the first data according to a clipping range determined based on the format information, multiply the clipped first data by a scaling factor determined based on the format information, discard a fractional part of a result of the multiplication, and wherein in response to the first and second data types being the same, the format converter is further configured to: discard some bits of the first data according to the format information.

According to an aspect of the present disclosure, there is provided a memory system comprises a memory controller configured to receive a format conversion command that instructs the conversion of first data having a first data type into second data having a second data type, and to generate format information based on the format conversion command, the memory controller including a format converter configured to receive the first data and generate the second data by converting the first data based on the format information, and a memory device, wherein in response to the first and second data types being different, the format converter is further configured to: clip the first data according to a clipping range determined based on the format information, multiply the clipped first data by a scaling factor determined based on the format information, discard a fractional part of a result of the multiplication, and wherein in response to the first and second data types being the same, the format converter is further configured to: discard some of all bits of the first data based on the format information.

According to an aspect of the present disclosure, there is provided a data format conversion method comprises receiving, by a memory device, a format conversion command that instructs the conversion of first data having a first data type into second data having a second data type, which is different from the first data type, generating, by the memory device, format information based on the format conversion command, clipping, by the memory device, the first data according to a clipping range determined based on the format information, multiplying, by the memory device, the clipped first data by a scaling factor determined based on the format information, and discarding, by the memory device, a fractional part of a result of the multiplication based on the format information to generate the second data.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a block diagram illustrating a memory system according to some example embodiments.

FIG. 2 is a block diagram illustrating a memory device according to some example embodiments.

FIG. 3 is a block diagram illustrating a format converter according to some example embodiments.

FIG. 4 is a flowchart illustrating how the format converter converts the format of data.

FIGS. 5 and 6 are diagrams illustrating the data conversion process of the format converter.

FIG. 7 is a block diagram illustrating a data read process according to some example embodiments.

FIG. 8 is a block diagram illustrating a data read process according to some example embodiments.

FIG. 9 is a flowchart illustrating the operation of a scrubbing circuit according to some example embodiments.

FIG. 10 is a block diagram illustrating a data write process according to some example embodiments.

FIG. 11 is a block diagram illustrating a data write process according to some example embodiments.

FIG. 12 is a block diagram illustrating a memory system according to some example embodiments.

FIG. 13 is a block diagram illustrating a memory system according to some example embodiments.

FIG. 14 is a block diagram illustrating a data read process according to some example embodiments.

FIG. 15 is a block diagram illustrating a data write process according to some example embodiments.

FIG. 16 is a diagram of a semiconductor package according to some example embodiments.

FIG. 17 is a diagram of a semiconductor package according to some example embodiments.

FIG. 18 is a diagram of a semiconductor package according to some example embodiments.

### DETAILED DESCRIPTION

Embodiments of the present disclosure will be described with reference to the attached drawings.

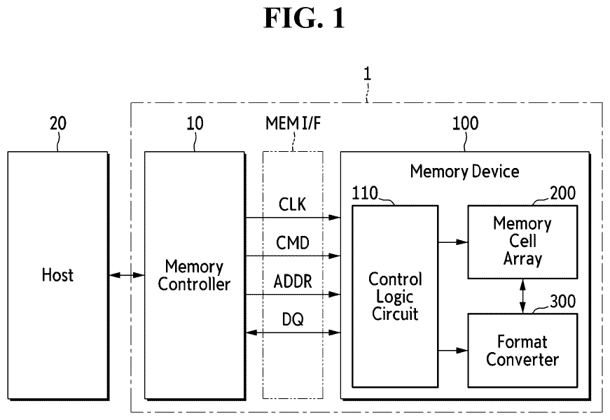

FIG. 1 is a block diagram illustrating a memory system according to some example embodiments.

Referring to FIG. 1, the memory system may include a host device 20 and a memory storage device 1. The memory storage device 1 may include a memory device 100 and a memory controller 10.

The memory controller 10 may generally control the operation of the memory device 100. For example, the memory controller 10 may control data exchange between the external host device 20 and the memory device 100. For example, the memory controller 10 may control the memory device 100 upon request from the host device 20, allowing data to be written or read to or from the memory device 100.

The memory controller 10 and the memory device 100 may communicate through a memory interface MEM I/F. In addition, the memory controller 10 and the external host device 20 may communicate through a host device interface. That is, the memory controller 10 may mediate signals between the memory device 100 and the host device 20. The memory controller 10 may apply commands CMD to control the operation of the memory device 100. Here, the memory device 100 may include dynamic memory cells. For example, the memory device 100 may include a dynamic random access memory (DRAM), a double data rate 4 synchronous DRAM (DDR4 SDRAM), a low-power DDR4 SDRAM (LPDDR4 SDRAM), or an LPDDR5 SDRAM, but the present disclosure is not limited thereto. Alternatively, the memory device 100 may include a non-volatile memory device. The memory device 100 will hereinafter be described as being a volatile memory device.

The memory controller 10 may transmit clock signals CLK, commands CMD, and addresses ADDR to the memory device 100. The memory controller 10 may provide data DQ to the memory device 100 and receive data DQ from the memory device 100. In some embodiments, the memory device 100 may include a memory cell array 200 where the data DQ is stored, a control logic circuit 110, and a format converter 300. The format converter 300 will be described later in detail.

The host device 20 may include, for example, processors that perform artificial intelligence (AI) operations, such as graphics processing units (GPUs), tensor processing units (TPUs), neural processing units (NPUs), or vision processing units (VPUs). Additionally, the host device 20 may include storage devices, such as solid-state drives (SSDs).

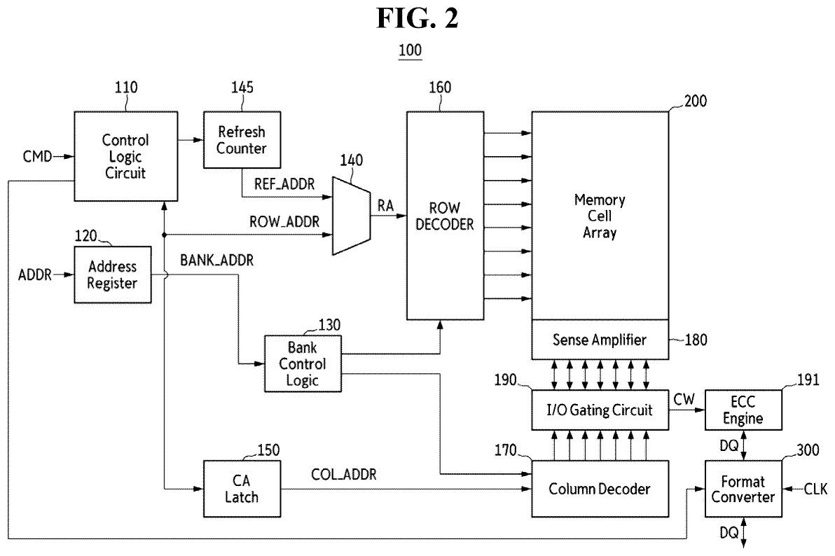

FIG. 2 is a block diagram illustrating a memory device according to some example embodiments.

Referring to FIG. 2, a memory device 100 may include a control logic circuit 110, an address register 120, a bank control logic circuit 130, a row address multiplexer 140, a refresh counter 145, a column address latch 150, a row decoder 160, a column decoder 170, a memory cell array 200, a sense amplifier unit 180, an input/output (I/O) gating circuit 190, an error correction code (ECC) engine 191, and a format converter 300.

The memory cell array 200 may include a plurality of bank memory arrays. The row decoder 160 may be connected to the bank memory arrays. The column decoder 170 may be connected to the bank memory arrays through the I/O gating circuit 190. The sense amplifier unit 180 may be connected to each of the bank memory arrays. The memory cell array 200 may include a plurality of wordlines, a plurality of bitlines, and a plurality of memory cells formed at the intersections of the wordlines and bitlines.

The address register 120 may receive an address ADDR from the memory controller 10. The address ADDR may include a bank address BANK_ADDR, a row address ROW_ADDR, and a column address COL_ADDR. The address register 120 may provide the bank address BANK_ADDR to the bank control logic circuit 130. The address register 120 may provide the row address ROW_ADDR to the row address multiplexer 140. The address register 120 may provide the column address COL_ADDR to the column address latch 150.

The bank control logic circuit 130 may generate a bank control signal in response to the bank address BANK_ADDR. The bank control logic circuit 130 may transit the bank control signal to the row decoder 160 and the column decoder 170. The row decoder 160 may be activated in response to the bank control signal corresponding to the bank address BANK_ADDR. Additionally, the column decoder 170 may be activated in response to the bank control signal corresponding to the bank address BANK_ADDR.

The row address multiplexer 140 may receive the row address ROW_ADDR from the address register 120 and the refresh row address REF_ADDR from the refresh counter 145. The row address multiplexer 140 may select one of the row address ROW_ADDR or the refresh row address REF_ADDR and output it as a row address RA. The row address RA may be provided to the row decoder 160.

The refresh counter 145 may sequentially output the refresh row address REF_ADDR under the control of the control logic circuit 110.

The row decoder 160, activated by the bank control logic circuit 130, may decode the row address RA output by the row address multiplexer 140 and activate the wordline corresponding to the row address RA. For example, the row decoder 160 may apply a wordline driving voltage to the wordline corresponding to the row address RA.

The column address latch 150 may receive the column address COL_ADDR from the address register 120 and temporarily store the received column address COL_ADDR. The column address latch 150 may incrementally increase the column address COL_ADDR in burst mode. The column address latch 150 may provide the temporarily stored or incrementally increased column address COL_ADDR to the column decoder 170.

The column decoder 170, activated by the bank control logic circuit 130, may activate the sense amplifier unit 180 corresponding to the bank address BANK_ADDR and the column address COL_ADDR through the corresponding I/O gating circuit 190.

The I/O gating circuit 190 may include circuits for gating I/O data, input data masking logic, read data latches for storing data output from the memory cell array 200, and write drivers for writing data to the memory cell array 200.

A codeword CW read from each of the bank memory arrays of the memory cell array 200 may be sensed by the corresponding sense amplifier unit 180. Additionally, the codeword CW may be stored in the corresponding read data latch. The stored codeword CW may be ECC-decoded by the ECC engine 191, and the ECC-decoded data DQ may be provided to the memory controller 10 through the format converter 300.

The format converter 300 may provide the data DQ to the ECC engine 191 during a write operation, based on the clock signal CLK. The format converter 300 may provide the data DQ provided by the ECC engine 191 to the memory controller 10 during a read operation, based on the clock signal CLK.

In some embodiments, the format converter 300 may convert the format of the data DQ during a write operation under the control of the control logic circuit 110 and provide it to the ECC engine 191. Here, the format may vary, for example, from 32-bit floating point (FP32) to 16-bit floating point (FP16 or BF16) to 8-bit integer (INT8), etc. The format converter 300 may convert the format of the data DQ provided by the ECC engine 191 during a read operation under the control of the control logic circuit 110 and provide it to the memory controller 10. This conversion may, for example, involve converting the data DQ from a first format (e.g., FP32) to a second format (e.g., INT8). In this case, the first format may be, but is not limited to, FP32, FP16, BF16, etc., and the second format may be, but is not limited to, FP16, BF16, INT7, INT4, etc.

The memory cell array 200 may be connected to the sense amplifier unit 180, and the row decoder 160 and column decoder 170 may be connected to the memory cell array 200 and the sense amplifier unit 180. The bitlines included in the memory cell array 200 may be connected to the sense amplifier unit 180 in an open bitline structure.

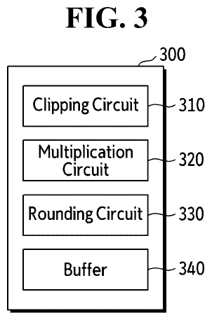

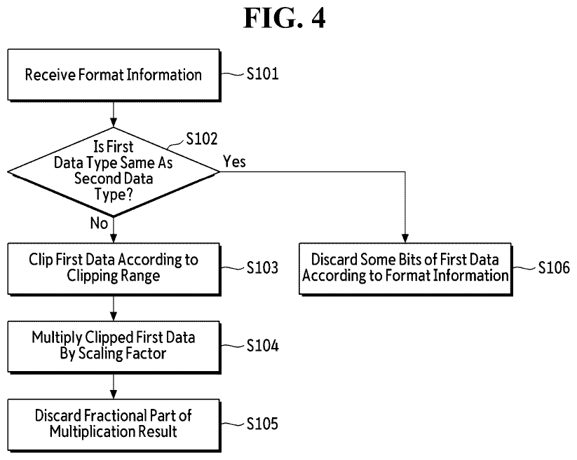

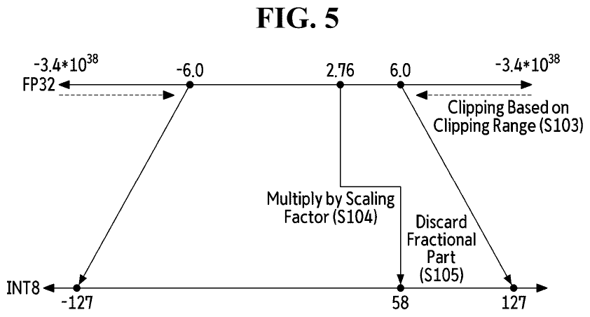

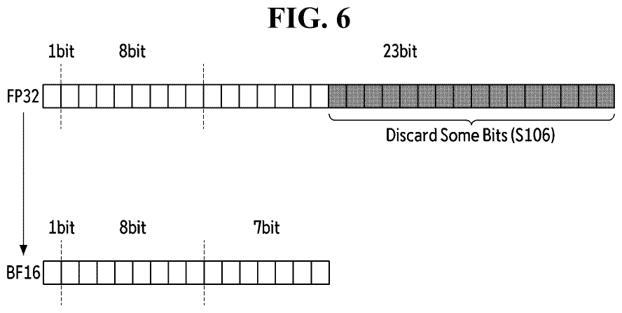

FIG. 3 is a block diagram illustrating a format converter according to some example embodiments. FIG. 4 is a flowchart illustrating how the format converter converts the format of data. FIGS. 5 and 6 are diagrams illustrating the data conversion process of the format converter.

Referring to FIGS. 3 through 6, a format converter 300 may include a clipping circuit 310, a multiplication circuit 320, a rounding circuit 330, and a buffer 340.

In some embodiments, the format converter 300 may convert the format of data based on the type of the data and the scaling factor and clipping range for the data. Here, the term “clipping” refers to replacing data outside a particular range in an array containing multiple data with the boundary values of the particular range. The term “clipping range” refers to the range defined by the aforementioned boundary values.

In some embodiments, the format converter 300 receives format information based on a format conversion command that directs the conversion of first data with a first data type into second data with a second data type (S101). First, it is assumed that the first data with the first data type refers to a real number of 2.76 in the FP32 format, while the second data with the second data type refers to the real number of 2.76 in the INT8 format. The real number of 2.76 is provided as an example, and the disclosure is not limited thereto. Accordingly, the first data type refers to a floating point (FP) type, and the second data type refers to an integer (INT) type.

In some embodiments, when the first and second data types are different (S102—No), the clipping circuit 310 may perform clipping on the first data based on the clipping range, as defined in the format information (S103). The format information may include information regarding the clipping range. If the clipping range is, for example, (−6, 6), the first data is not replaced with the boundary value of −6 or 6 because the real number of 2.76 is greater than −6 and less than 6. However, if the first data refers to a real number of 10, it may be replaced with the boundary value of 6. On the other hand, if the first data type and second data type are the same, such as both being floating points, the clipping operation of the clipping circuit 310 may be omitted.

In some embodiments, the multiplication circuit 320 may multiply the clipped first data by a scaling factor s when the first and second data types are different (S104). For example, since the clipped first data refers to the real number of 2.76, the multiplication circuit 320 may multiply 2.76 by the scaling factor s. The scaling factor s may be determined by the following equation:

$$s = \frac{M}{r}$$

where M represents the difference (e.g., 127−(−127)=254) between the maximum and minimum values that can be represented by the bit width of the second format (i.e., INT8), and r represents the difference (e.g., 6−(−6)=12) between the maximum and minimum boundary values of the clipping range. Thus, the result of the multiplication is 58.42 (=2.76*(254/12)).

On the other hand, if the first and second data types are the same, such as both being floating points, the multiplication operation of the multiplication circuit 320 may be omitted.

In some embodiments, the rounding circuit 330 may discard the fractional part of the result of the multiplication (S105) when the first and second data types are different (S102—No). For example, the rounding circuit 330 may generate the second data in the INT8 format, i.e., 58, by discarding the fractional part of the result of the multiplication, i.e., 0.42.

When the first and second data types are the same (S102—Yes), the rounding circuit 330 may also discard some of the bits of the first data based on the format information(S106). In this case, contrary to what has been described earlier, it is assumed that the first data with the first data type is the real number of 2.76 in the FP32 format, while the second data with the second data type is the real number of 2.76 in the BF16 format. FP32 data has 1 sign bit, 8 exponent bits, and 23 mantissa bits, while BF16 data has 1 sign bit, 8 exponent bits, and 7 mantissa bits. The rounding circuit 330 may discard some bits from the first data based on the difference between the FP32 format and the BF16 format. Accordingly, the rounding circuit 330 may discard the lower 16 bits from among the 23 mantissa bits.

The buffer 340 may provide the data DQ whose format has been converted to the ECC engine 191 during a write operation based on the clock signal CLK. During a read operation, the format converter 300 may provide the data DQ whose format has been converted to the memory controller 10 based on the clock signal CLK.

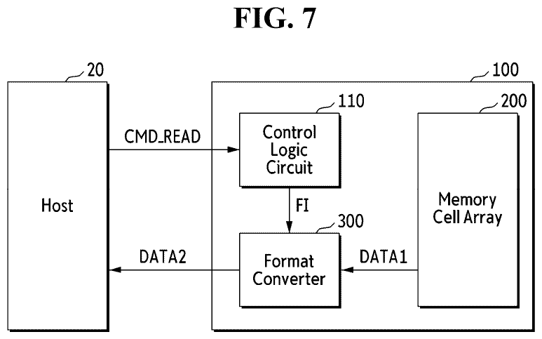

FIG. 7 is a block diagram illustrating a data read process according to some example embodiments.

Referring to FIG. 7, a host device 20 may provide a read command CMD_READ for first data DATA1 through a memory controller (e.g., memory controller 10 in FIG. 1).

In some embodiments, the read command CMD_READ includes a format conversion command that instructs the conversion of first data DATA1 with a first data type into second data DATA2 with a second data type and specifies the clipping range for the first data DATA1 and the bit width of the second data DATA2. In other words, the host device 20 may specify and command the type, clipping range, and bit width of the second data DATA2, into which first data DATA1 is to be converted, through the read command CMD_READ. As previously described, since the scaling factor is determined based on the bit width and clipping range for the second data DATA2, the host device 20 may specify the scaling factor to be applied to the first data DATA1 by specifying the bit width of the second data DATA2. For example, the host device 20 may instruct the conversion of the first data DATA1, which refers to a real number of 2.76 and has the first data type (e.g., the FP type), into the second data DATA2, which has the second data type (e.g., the INT type). Additionally, the host device 20 may specify the clipping range for the first data DATA1 as (−6, 6). The host device 20 may also specify the bit width of the second data DATA2 to be 8 bits.

The control logic circuit 110 may receive the read command CMD_READ and generate format information FI based on the format conversion command included in the read command CMD_READ. The generated format information FI may include information on the data type of the second data DATA2 specified by the host device 20, the clipping range for the first data DATA1 specified by the host device 20, and the bit width of the second data DATA2 specified by the host device 20. A format converter 300 may receive the first data DATA1 from the memory cell array 200, and generate the second data DATA2 by converting the format of the first data DATA1 based on the generated format information FI. The format converter 300 may output the generated second data DATA2 to the host device 20.

In some embodiments, a memory device 100 may receive a format conversion command from the host device 20, and by converting the format of data through the format converter 300 of the memory device 100, the memory device 100 and auxiliary processors such as GPUs and NPUs may directly exchange data without the mediation of a central processing unit (CPU), even when quantization or data format conversion is required for the data. As a result, the transfer path for the data can be simplified, alleviating data bottlenecks and reducing the load on the CPU, which is responsible for system management.

Furthermore, when performing inference operations, the auxiliary processors such as GPUs and NPUs may require data to have different formats. For example, some data (e.g., input data for inference operations) may require the FP32 format to maintain data accuracy, while other data (e.g., weights in inference operations) may require the INT8 format to simplify operations. In some embodiments, the host device 20 may specify the format of the data to be written to or read from the memory device 100, allowing the host device 20 to flexibly utilize the data.

In some embodiments, the format conversion command included in the read command CMD_READ may instruct the conversion of the first data DATA1 with the first data type into the second data DATA2 with the second data type and specify the clipping range for the first data DATA1. In this case, contrary to what has been described earlier, the bit width of the second data DATA2, into which the first data DATA1 is to be converted, may be pre-set within the memory device 100. In other words, the host device 20 may specify the type and clipping range for the second data DATA2, into which the first data DATA1 is to be converted, through the read command CMD_READ, but may not specify the bit width of the second data DATA2. For example, the host device 20 may instruct the conversion of the first data DATA1, which refers to a real number of 2.76 and has the first data type (e.g., the FP type), into the second data DATA2, which has the second data type (e.g., the INT type). Additionally, the host device 20 may specify the clipping range for the first data DATA1 as (−6, 6). In this case, the bit width of the second data DATA2, into which the first data DATA1 is to be converted, may be pre-set to 8 bits within the control logic circuit 110.

The control logic circuit 110 may receive the read command CMD_READ and generate format information FI based on the format conversion command included in the read command CMD_READ. The generated format information FI may include information on the data type of the second data DATA2 specified by the host device 20, the clipping range for the first data DATA1 specified by the host device 20, and the bit width of the second data DATA2 pre-set within the control logic circuit 110. The format converter 300 may receive the first data DATA1 from the memory cell array 200, and generate the second data DATA2 by converting the format of the first data DATA1 based on the generated format information FI. The format converter 300 may output the generated second data DATA2 to the host device 20.

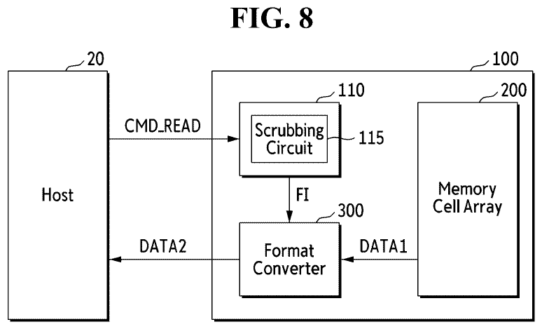

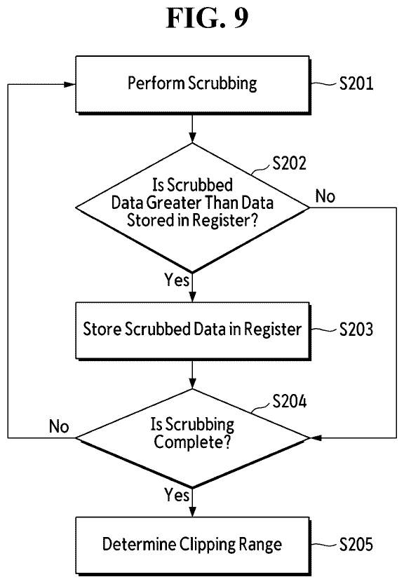

FIG. 8 is a block diagram illustrating a data read process according to some example embodiments. FIG. 9 is a flowchart illustrating the operation of a scrubbing circuit according to some example embodiments.

Referring to FIGS. 8 and 9, a control logic circuit 110 may include a scrubbing circuit 115.

In some embodiments, the scrubbing circuit 115 performs scrubbing on multiple data stored in a memory cell array 200 (S201). Scrubbing refers to periodically checking for errors in the data stored in the memory cell array 200 or performing error checks and corrections in response to a command from a host device 20 or the control logic circuit 110. The scrubbing circuit 115 may include an ECC engine and a register for error checking and correction. The scrubbing circuit 115 compares the value indicated by scrubbed data among the multiple data to the value stored in the register (S202). If the value indicated by the scrubbed data is greater than the value stored in the register (S202—Yes), the scrubbing circuit 115 deletes the data stored in the register and stores the scrubbed data in the register (S203). For example, if the value indicated by the scrubbed data is 6 and the value stored in the register is 5, the scrubbing circuit 115 may delete the data stored in the register and store the scrubbed data. Thereafter, a determination is made as to whether scrubbing has been completed for all the data (S204). If the value stored in the register is greater than or equal to the value indicated by the scrubbed data (S202—No), step S203 may be skipped, and a determination may be made as to whether scrubbing has been completed for all the multiple data (S204). If scrubbing is completed (S204—Yes), the control logic circuit 110 determines the clipping range based on the data stored in the register, i.e., whichever of the multiple data stored in the memory cell array has a largest value (S205). If scrubbing is not completed (S204—No), scrubbing is continued (S201). For example, if scrubbing is completed and the value stored in the register is 6, the clipping range may be determined as (−6, 6).

In some embodiments, the host device 20 may provide a read command CMD_READ for first data DATA1 through a memory controller (e.g., memory controller 10 in FIG. 1). The format conversion command included in the read command CMD_READ may instruct the conversion of first data DATA1 with a first data type into second data DATA2 with a second data type and specify the bit width of the second data DATA2. In other words, the host device 20 may specify and command the type and bit width of the second data DATA2, to which the first data DATA1 is to be converted, through the read command CMD_READ. The clipping range for the first data DATA1 may be determined by the scrubbing circuit 115.

For example, the host device 20 may instruct the conversion of the first data DATA1, which refers to a real number of 2.76 and has the first data type (e.g., the FP type), into the second data DATA2, which has the second data type (e.g., the INT type). The host device 20 may also specify the bit width of the second data DATA2 to be 8 bits. The clipping range for the first data DATA1 may be determined as (−6, 6) by the scrubbing circuit 115 of the control logic circuit 110.

The control logic circuit 110 may receive the read command CMD_READ and generate format information FI based on the format conversion command included in the read command CMD_READ. The generated format information FI may include the data type of the second data DATA2 specified by the host device 20, the bit width of the second data DATA2 specified by the host device 20, and the clipping range for the first data DATA1 determined by the scrubbing circuit 115 of the control logic circuit 110. A format converter 300 may receive the first data DATA1 from the memory cell array 200, and generate the second data DATA2 by converting the format of the first data DATA1 based on the generated format information FI. The format converter 300 may output the generated second data DATA2 to the host device 20.

In some embodiments, the format conversion command included in the read command CMD_READ may instruct the conversion of the first data DATA1 with the first data type into the second data DATA2 with the second data type. In this case, contrary to what has been described earlier, the bit width of the second data DATA2, into which the first data DATA1 is to be converted, may be pre-set within a memory device 100. In other words, the host device 20 may specify the type of the second data DATA2, into which the first data DATA1 is to be converted, through the read command CMD_READ, but may not specify the bit width of the second data DATA2. The clipping range for the first data DATA1 may be determined by the scrubbing circuit 115.

For example, the host device 20 may instruct the conversion of the first data DATA1, which refers to the real number of 2.76 and has the first data type (e.g., the FP type), into the second data DATA2, which has the second data type (e.g., the INT type). Additionally, the scrubbing circuit 115 of the control logic circuit 110 may determine the clipping range for the first data DATA1 as (−6, 6). In this case, the bit width of the second data DATA2, into which the first data DATA1 is to be converted, may be pre-set to 8 bits within the memory device 100.

The control logic circuit 110 may receive the read command CMD_READ and generate format information FI based on the format conversion command included in the read command CMD_READ. The generated format information FI may include the data type of the second data DATA2 specified by the host device 20, the clipping range for the first data DATA1 determined by the scrubbing circuit 115 of the control logic circuit 110, and the bit width of the second data DATA2 pre-set within the control logic circuit 110. The format converter 300 may receive the first data DATA1 from the memory cell array 200, and generate the second data DATA2 by converting the format of the first data DATA1 based on the generated format information FI. The format converter 300 may output the generated second data DATA2 to the host device 20.

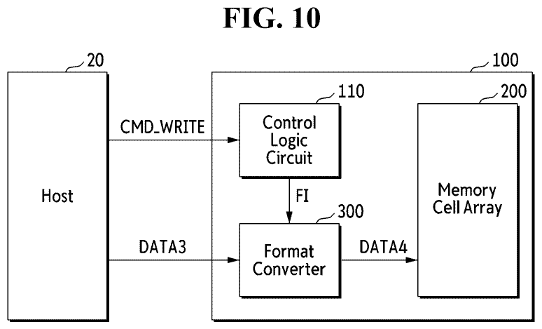

FIG. 10 is a block diagram illustrating a data write process according to some example embodiments.

Referring to FIG. 10, a host device 20 may provide third data DATA3 and a write command CMD_WRITE for the third data DATA3 through a memory controller (e.g., memory controller 10 in FIG. 1).

In some embodiments, the format conversion command included in the write command CMD_WRITE may instruct the conversion of third data DATA3 with a third data type into fourth data DATA4 with a fourth data type and specify the clipping range for the third data DATA3 and the bit width of the fourth data DATA4. In other words, the host device 20 may specify and command the data type, clipping range, and bit width of the fourth data DATA4, into which the third data DATA3 is to be converted, through the write command CMD_WRITE. As previously described, since the scaling factor is determined based on the bit width and clipping range for the fourth data DATA4, the host device 20 may specify the scaling factor to be applied to the third data DATA3 by specifying the bit width of the fourth data DATA4. For example, the host device 20 may instruct the conversion of the third data DATA3, which refers to a real number of 2.76 and has the third data type (e.g., the FP type), into the fourth data DATA4, which has the fourth data type (e.g., the INT type). Additionally, the host device 20 may specify the clipping range for the third data DATA3 as (−6, 6). The host device 20 may also specify the bit width of the fourth data DATA4 to be 8 bits.

A control logic circuit 110 may receive the write command CMD_WRITE and generate format information FI based on the format conversion command included in the write command CMD_WRITE. The generated format information FI may include the data type of fourth data DATA4 specified by the host device 20, the clipping range for the third data DATA3 specified by the host device 20, and the bit width of the fourth data DATA4 specified by the host device 20. A format converter 300 may receive the third data DATA3 from the host device 20, and generate the fourth data DATA4 by converting the format of the third data DATA3 based on the generated format information FI. The format converter 300 may store the generated fourth data DATA4 in a memory cell array 200.

In some embodiments, the format conversion command included in the write command CMD_WRITE may instruct the conversion of the third data DATA3 with the third data type into the fourth data DATA4 with the fourth data type and specify the clipping range for the third data DATA3. In this case, contrary to what has been described earlier, the bit width of the fourth data DATA4, into which the third data DATA3 is to be converted, may be pre-set within a memory device 100. In other words, the host device 20 may specify the data type and clipping range for the fourth data DATA4, into which the third data DATA3 is to be converted, through the write command CMD_WRITE, but may not specify the bit width of the fourth data DATA4. For example, the host device 20 may instruct the conversion of the third data DATA3, which refers to the real number of 2.76 and has the first data type (e.g., the FP type), into the fourth data DATA4, which has the second data type (e.g., the INT type). Additionally, the host device 20 may specify the clipping range for the third data DATA3 as (−6, 6). In this case, the bit width of the fourth data DATA4, into which the third data DATA3 is to be converted, may be pre-set to 8 bits within the memory device 100.

The control logic circuit 110 may receive the write command CMD_WRITE and generate format information FI based on the format conversion command included in the write command CMD_WRITE. The generated format information FI may include the data type of the fourth data DATA4 specified by the host device 20, the clipping range for the third data DATA3 specified by the host device 20, and the pre-set bit width of the fourth data DATA4 within the control logic circuit 110. The format converter 300 may receive the third data DATA3 from the host device 20, and generate the fourth data DATA4 by converting the format of the third data DATA3 based on the generated format information FI. The format converter 300 may store the generated fourth data DATA4 in the memory cell array 200.

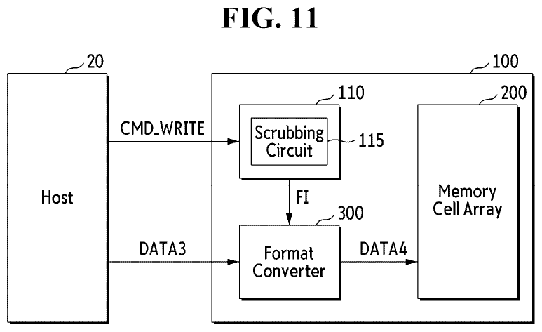

FIG. 11 is a block diagram illustrating a data write process according to some example embodiments.

Referring to FIG. 11, a control logic circuit 110 may include a scrubbing circuit 115. The operation of the scrubbing circuit 115 has already been described earlier, and thus a detailed description thereof will not be repeated.

In some embodiments, a host device 20 may provide a write command CMD_WRITE for third data DATA3 through the memory controller 10 in FIG. 1. The format conversion command included in the write command CMD_WRITE may instruct the conversion of third data DATA3 with a third data type into fourth data DATA4 with a fourth data type and specify the bit width of the fourth data DATA4. In other words, the host device 20 may specify and command the type and bit width of the fourth data DATA4, into which the third data DATA3 is to be converted, through the write command CMD_WRITE. The clipping range for the third data DATA3 may be determined by the scrubbing circuit 115.

For example, the host device 20 may instruct the conversion of the third data DATA3, which refers to a real number of 2.76 and has the FP type, into fourth data DATA4 with the INT type. The host device 20 may also specify the bit width of the fourth data DATA4 to be 8 bits. The clipping range for the third data DATA3 may be determined as (−6, 6) by the scrubbing circuit 115 of the control logic circuit 110.

The control logic circuit 110 may receive the write command CMD_WRITE and generate format information FI based on the format conversion command included in the write command CMD_WRITE. The generated format information FI may include the data type of the fourth data DATA4 specified by the host device 20, the bit width of the fourth data DATA4 specified by the host device 20, and the clipping range for the third data DATA3 determined by the scrubbing circuit 115 of the control logic circuit 110. The format converter 300 may receive the third data DATA3 from the host device 20, and generate the fourth data DATA4 by converting the format of the third data DATA3 based on the generated format information FI. The format converter 300 may store the generated fourth data DATA4 in a memory cell array 200.

In some embodiments, the format conversion command included in the write command CMD_WRITE may instruct the conversion of the third data DATA3 with the third data type into the fourth data DATA4 with the fourth data type and specify the clipping range for the third data DATA3. In this case, contrary to what has been described earlier, the bit width of the fourth data DATA4, into which the third data DATA3 is to be converted, may be pre-set within a memory device 100. In other words, the host device 20 may specify the type and clipping range for the fourth data DATA4, into which the third data DATA3 is to be converted, through the write command CMD_WRITE, but may not specify the bit width of the fourth data DATA4. The clipping range for the third data DATA3 may be determined by the scrubbing circuit 115.

For example, the host device 20 may instruct the conversion of the third data DATA3, which refers to a real number 2.76 and has the first data type (e.g., the FP type), into the fourth data DATA4, which has the second data type (e.g., the INT type). Additionally, the scrubbing circuit 115 of the control logic circuit 110 may determine the clipping range for the third data DATA3 as (−6, 6). In this case, the bit width of the fourth data DATA4, into which the third data DATA3 is to be converted, may be pre-set to 8 bits within the memory device 100.

The control logic circuit 110 may receive the write command CMD_WRITE and generate format information FI based on the format conversion command included in the write command CMD_WRITE. The generated format information FI may include the data type of the fourth data DATA4 specified by the host device 20, the clipping range for the third data DATA3 determined by the scrubbing circuit 115 of the control logic circuit 110, and the bit width of the fourth data DATA4 pre-set within the control logic circuit 110. The format converter 300 may receive the third data DATA3 from the host device 20, and generate the fourth data DATA4 by converting the format of the third data DATA3 based on the generated format information FI. The format converter 300 may store the generated fourth data DATA4 in the memory cell array 200.

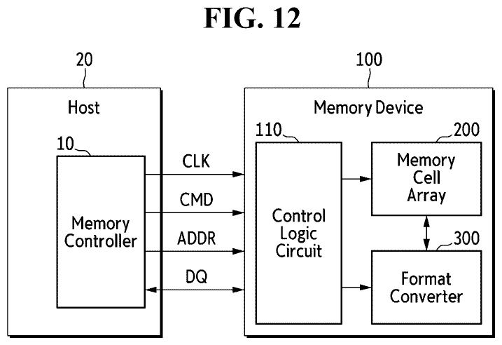

FIG. 12 is a block diagram illustrating a memory system according to some example embodiments.

Referring to FIG. 12, the host device 20 may include a memory controller 10. That is, in the embodiment of FIG. 12, unlike in the embodiment of FIG. 1 where the memory controller 10 is located outside the host device 20, the host device 20 may include the memory controller 10. The host device 20 may control a memory device 100 through the memory controller 10. For example, the memory controller 10 included in the host device 20 may transmit clock signals CLK, commands CMD, and addresses ADDR to the memory device 100, and may provide data DQ to the memory device 100 and receive data DQ from the memory device 100. Here, the host device 20 may communicate with the memory device 100 based on one of the standards such as Double Data Rate (DDR), Low Power Double Data Rate (LPDDR), Graphics Double Data Rate (GDDR), Wide I/O, High Bandwidth Memory (HBM), Hybrid Memory Cube (HMC), or Compute Express Link (CXL).

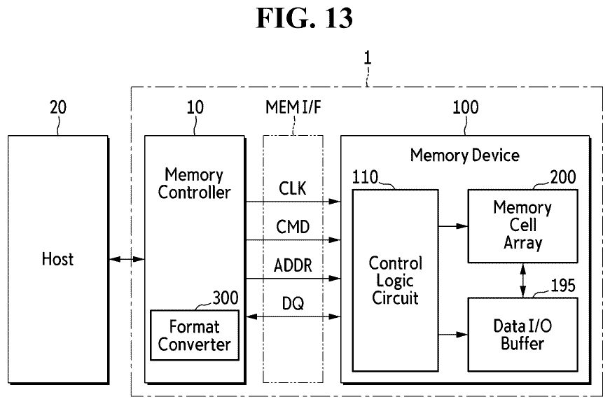

FIG. 13 is a block diagram illustrating a memory system according to some example embodiments.

Referring to FIG. 13, contrary to what has been described earlier, a format converter 300 may be located outside a memory device 100. The format converter 300 may be included in, for example, a memory controller 10. For example, the format converter 300 may be located in the memory controller 10, which is included in the memory storage device 1. However, the location of the format converter 300 is not particularly limited and may be positioned outside the memory controller 10.

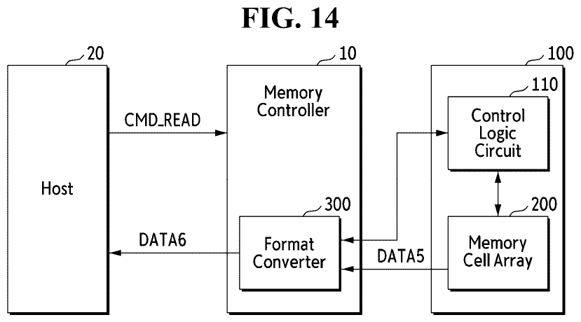

FIG. 14 is a block diagram illustrating a data read process according to some example embodiments.

Referring to FIG. 14, a host device 20 may provide a read command CMD_READ for fifth data DATA5 to a memory controller 10.

In some embodiments, the format conversion command included in the read command CMD_READ may instruct the conversion of fifth data DATA5 with a fifth data type into sixth data DATA6 with a sixth data type and specify the clipping range for the fifth data DATA5 and the bit width of the sixth data DATA6. In other words, the host device 20 may specify and command the type of and the clipping range and bit width of the sixth data DATA6, into which the fifth data DATA5 is to be converted, through the read command CMD_READ. As described earlier, since the scaling factor is determined based on the bit width and clipping range for the sixth data DATA6, the host device 20 may specify the scaling factor to be applied to the fifth data DATA5 by specifying the bit width of the sixth data DATA6. For example, the host device 20 may instruct the conversion of the fifth data DATA5, which refers to a real number of 2.76 and has the fifth data type (e.g., the FP type), into the sixth data DATA6, which has the sixth data type (e.g., the INT type). Additionally, the host device 20 may specify the clipping range for the fifth data DATA5 as (−6, 6). The host device 20 may also specify the bit width of the sixth data DATA6 to be 8 bits.

The memory controller 10 may receive the read command CMD_READ and generate format information FI based on the format conversion command included in the read command CMD_READ. The generated format information FI may include the data type of the sixth data DATA6 specified by the host device 20, the clipping range for the fifth data DATA5 specified by the host device 20, and the bit width of the sixth data DATA6 specified by the host device 20. A format converter 300 may receive the fifth data DATA5 from a memory device 100, and generate the sixth data DATA6 by converting the format of the fifth data DATA5 based on the generated format information FI. The format converter 300 may output the generated sixth data DATA6 to the host device 20.

In some embodiments, the format conversion command included in the read command CMD_READ may instruct the conversion of the fifth data DATA5 with the fifth data type into the sixth data DATA6 with the sixth data type and specify the clipping range for the fifth data DATA5. In this case, contrary to what has been described earlier, the bit width of the sixth data DATA6, into which the fifth data DATA5 is to be converted, may be pre-set within the memory controller 10. In other words, the host device 20 may specify the type and clipping range for the sixth data DATA6, into which the fifth data DATA5 is to be converted, through the read command CMD_READ, but may not specify the bit width of the sixth data DATA6. For example, the host device 20 may instruct the conversion of fifth data DATA5 (e.g., a real number of 2.76) with the FP type into sixth data DATA6 with the INT type. Additionally, the host device 20 may specify the clipping range for the fifth data DATA5 as (−6, 6). In this case, the bit width of the sixth data DATA6, into which the fifth data DATA5 is to be converted, may be pre-set to 8 bits within the memory controller 10.

The memory controller 10 may receive the read command CMD_READ and generate format information FI based on the format conversion command included in the read command CMD_READ. The generated format information FT may include the data type of the sixth data DATA6 specified by the host device 20, the clipping range for the fifth data DATA5 specified by the host device 20, and the bit width of the sixth data DATA6 pre-set within the control logic circuit 110. The format converter 300 may receive the fifth data DATA5 from the memory device 100, and generate the sixth data DATA6 by converting the format of the fifth data DATA5 based on the generated format information FI. The format converter 300 may output the generated sixth data DATA6 to the host device 20.

In some embodiments, the control logic circuit 110 of the memory device 100 may include a scrubbing circuit. The operation of the scrubbing circuit has already been described earlier, and thus, a description thereof will not be repeated. The scrubbing circuit may determine the clipping range for the fifth data DATA5 and provide it to the memory controller 10. The host device 20 may provide the memory controller 10 with the read command CMD_READ for the fifth data DATA5. The format conversion command included in the read command CMD_READ may instruct the conversion of the fifth data DATA5 with the fifth data type into the sixth data DATA6 with the sixth data type and specify the bit width of the sixth data DATA6. In other words, the host device 20 may specify and command the type and bit width of the sixth data DATA6, into which the fifth data DATA5 is to be converted, through the read command CMD_READ. The clipping range for fifth data DATA5 may be received from the scrubbing circuit of the memory device 100.

For example, the host device 20 may instruct the conversion of the fifth data DATA5, which refers to a real number of 2.76 and has the fifth data type (e.g., the FP type), into sixth data DATA6, which has the sixth data type (e.g., the INT type). The host device 20 may also specify the bit width of the sixth data DATA6 to be 8 bits. The clipping range for the fifth data DATA5 may be determined as (−6, 6) by the scrubbing circuit of the control logic circuit 110.

The memory controller 10 may receive the read command CMD_READ and generate format information FT based on the format conversion command included in the read command CMD_READ. The generated format information FT may include the data type of the sixth data DATA6 specified by the host device 20, the clipping range for the fifth data DATA5 determined by the scrubbing circuit of the control logic circuit 110, and the bit width of sixth data DATA6 pre-set within the control logic circuit 110. The format converter 300 may receive the fifth data DATA5 from the memory device 100, and generate the sixth data DATA6 by converting the format of the fifth data DATA5 based on the generated format information FI. The format converter 300 may output the generated sixth data DATA6 to the host device 20.

In some embodiments, the format conversion command included in the read command CMD_READ may instruct the conversion of the fifth data DATA5 with the fifth data type into the sixth data DATA6 with the sixth data type. In this case, contrary to what has been described earlier, the bit width of the sixth data DATA6, into which the fifth data DATA5 is to be converted, may be pre-set within the memory device 100. In other words, the host device 20 may specify the type of the sixth data DATA6, into which the fifth data DATA5 is to be converted, through the read command CMD_READ, but may not specify the bit width of the sixth data DATA6. The clipping range for the fifth data DATA5 may be determined by the scrubbing circuit.

For example, the host device 20 may instruct the conversion of the fifth data DATA5, which refers to the real number 2.76 and has the fifth data type (e.g., the FP type), into the sixth data DATA6, which has the sixth data type (e.g., the INT type). Additionally, the scrubbing circuit of the control logic circuit 110 may determine the clipping range for the fifth data DATA5 as (−6, 6). In this case, the bit width of the sixth data DATA6, into which the fifth data DATA5 is to be converted, may be pre-set to 8 bits within the memory controller 10.

The memory controller 10 may receive the read command CMD_READ and generate format information FT based on the format conversion command included in the read command CMD_READ. The generated format information FT may include the data type of the sixth data DATA6 specified by the host device 20, the clipping range for the fifth data DATA5 determined by the scrubbing circuit of the control logic circuit 110, and the bit width of the sixth data DATA6 pre-set within the control logic circuit 110. The format converter 300 may receive the fifth data DATA5 from the memory device 100, and generate the sixth data DATA6 by converting the format of the fifth data DATA5 based on the generated format information FI. The format converter 300 may output the generated sixth data DATA6 to the host device 20.

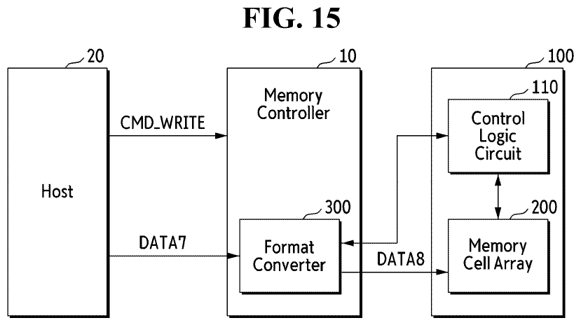

FIG. 15 is a block diagram illustrating a data write process according to some example embodiments.

Referring to FIG. 15, a host device 20 may provide seventh data DATA7 and a write command CMD_WRITE for the seventh data DATA7 to a memory controller 10.

In some embodiments, the format conversion command included in the write command CMD_WRITE may instruct the conversion of seventh data DATA7 with a seventh data type into eighth data DATA8 with an eighth data type and specify the clipping range for the seventh data DATA7 and the bit width of the eighth data DATA8. In other words, the host device 20 may specify and command the data type, clipping range, and bit width of the eighth data DATA8, into which the seventh data DATA7 is to be converted, through the write command CMD_WRITE. As described earlier, since the scaling factor is determined based on the bit width and clipping range for the eighth data DATA8, the host device 20 may specify the scaling factor to be applied to the seventh data DATA7 by specifying the bit width of the eighth data DATA8. For example, the host device 20 may instruct the conversion of the seventh data DATA7, which refers to a real number 2.76 and has the seventh data type (e.g., the FP type), into the eighth data DATA8, which has the eighth data type (e.g., the INT type). Additionally, the host device 20 may specify the clipping range for the seventh data DATA7 as (−6, 6). The host device 20 may also specify the bit width of the eighth data DATA8 to be 8 bits.

The memory controller 10 may receive the write command CMD_WRITE and generate format information FT based on the format conversion command included in the write command CMD_WRITE. The generated format information FT may include the data type of the eighth data DATA8 specified by the host device 20, the clipping range for the seventh data DATA7 specified by the host device 20, and the bit width of the eighth data DATA8 specified by the host device 20. A format converter 300 may receive the seventh data DATA7 from the host device 20, and generate the eighth data DATA8 by converting the format of the seventh data DATA7 based on the generated format information FT. The format converter 300 may store the generated eighth data DATA8 in a memory device 100.

In some embodiments, the format conversion command included in the write command CMD_WRITE may instruct the conversion of the seventh data DATA7 with the seventh data type into the eighth data DATA8 with the eighth data type and specify the clipping range for the seventh data DATA7. In this case, contrary to what has been described earlier, the bit width of the eighth data DATA8, into which the seventh data DATA7 is to be converted, may be pre-set within the memory controller 10. In other words, the host device 20 may specify the type and clipping range for the eighth data DATA8, into which the seventh data DATA7 is to be converted, through the write command CMD_WRITE, but may not specify the bit width of the eighth data DATA8. For example, the host device 20 may instruct the conversion of the seventh data DATA7, which refers to the real number 2.76 and has the seventh data type (e.g., the FP type), into the eighth data DATA8, which has the eighth data type (e.g., the INT type). Additionally, the host device 20 may specify the clipping range for the seventh data DATA7 as (−6, 6). In this case, the bit width of the eighth data DATA8, into which the seventh data DATA7 is to be converted, may be pre-set to 8 bits within the memory controller 10.

The memory controller 10 may receive the write command CMD_WRITE and generate format information FT based on the format conversion command included in the write command CMD_WRITE. The generated format information FT may include the data type of the eighth data DATA8 specified by the host device 20, the clipping range for the seventh data DATA7 specified by the host device 20, and the bit width of the eighth data DATA8 pre-set within the memory controller 10. The format converter 300 may receive the seventh data DATA7 from the host device 20, and generate the eighth data DATA8 by converting the format of the seventh data DATA7 based on the generated format information FT. The format converter 300 may store the generated eighth data DATA8 in the memory device 100.

In some embodiments, the host device 20 may provide the write command CMD_WRITE for the seventh data DATA7 to the memory controller 10. The format conversion command included in the write command CMD_WRITE may instruct the conversion of the seventh data DATA7 with the seventh data type into the eighth data DATA8 with the eighth data type and specify the bit width of the eighth data DATA8. In other words, the host device 20 may specify and command the type and bit width of the eighth data DATA8, into which the seventh data DATA7 is to be converted, through the write command CMD_WRITE. In this case, the clipping range for the seventh data DATA7 may be determined by a scrubbing circuit of a control logic circuit 110.

For example, the host device 20 may instruct the conversion of the seventh data DATA7, which refers to the real number of 2.76 and has the seventh data type (e.g., the FP type), into the eighth data DATA8, which has the eighth data type (e.g., the INT type). The host device 20 may also specify the bit width of the eighth data DATA8 to be 8 bits. The clipping range for the seventh data DATA7 may be determined as (−6, 6) by the scrubbing circuit of the control logic circuit 110.

The memory controller 10 may receive the write command CMD_WRITE and generate format information FI based on the format conversion command included in the write command CMD_WRITE. The generated format information FI may include the data type of the eighth data DATA8 specified by the host device 20, the bit width of the eighth data DATA8 specified by the host device 20, and the clipping range for the seventh data DATA7 determined by the scrubbing circuit of the control logic circuit 110. The format converter 300 may receive the seventh data DATA7 from the host device 20, and generate the eighth data DATA8 by converting the format of the seventh data DATA7 based on the generated format information FI. The format converter 300 may store the generated eighth data DATA8 in the memory device 100.

In some embodiments, the format conversion command included in the write command CMD_WRITE may instruct the conversion of the seventh data DATA7 with the seventh data type into the eighth data DATA8 with the eighth data type. In this case, contrary to what has been described earlier, the bit width of the eighth data DATA8, into which the seventh data DATA7 is to be converted, may be pre-set within the memory controller 10. In other words, the host device 20 may specify the type of the eighth data DATA8, into which the seventh data DATA7 is to be converted, through the write command CMD_WRITE, but may not specify the bit width of the eighth data DATA8. The clipping range for the seventh data DATA7 may be determined by the scrubbing circuit.

For example, the host device 20 may instruct the conversion of the seventh data DATA7, which refers to the real number of 2.76 and has the seventh data type (e.g., the FP type), into the eighth data DATA8, which has the eighth data type (e.g., the INT type). Additionally, the scrubbing circuit of the control logic circuit 110 may determine the clipping range for the seventh data DATA7 as (−6, 6). In this case, the bit width of the eighth data DATA8, into which the seventh data DATA7 is to be converted, may be pre-set to 8 bits within the memory controller 10.

The memory controller 10 may receive the write command CMD_WRITE and generate format information FT based on the format conversion command included in the write command CMD_WRITE. The generated format information FT may include the data type of the eighth data DATA8 specified by the host device 20, the clipping range for the seventh data DATA7 determined by the scrubbing circuit of the control logic circuit 110, and the bit width of the eighth data DATA8 pre-set within the memory controller 10. The format converter 300 may receive the seventh data DATA7 from the host device 20, and generate the eighth data DATA8 by converting the format of the seventh data DATA7 based on the generated format information FI. The format converter 300 may store the generated eighth data DATA8 in the memory device 100.

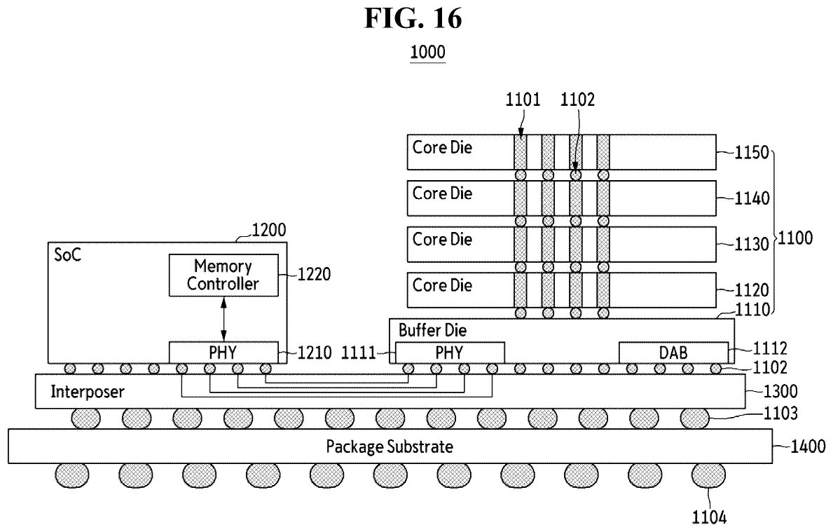

FIG. 16 is a diagram of a semiconductor package according to some example embodiments.

Referring to FIG. 16, a semiconductor package 1000 may include a stacked memory device 1100, a system-on-chip (SoC) 1200, an interposer 1300, and a package substrate 1400. The stacked memory device 1100 may include a buffer die 1110 and core dies 1120 through 1150. Each of the core dies 1120 through 1150 may include the memory device 100 of any one of FIGS. 1 through 15. The buffer die 1110 may include a physical layer (“PHY”) 1111 and a direct access block (“DAB”) 1112. The physical layer 1111 may be electrically connected to a physical layer (“PHY”) 1210 of the SoC 1200 through the interposer 1300. The stacked memory device 1100 may receive signals from or transmit signals to the SoC 1200 via the physical layer 1111.

The direct access block 1112 may provide an access path that allows testing of the stacked memory device 1100 without the mediation of the SoC 1200. The direct access block 1112 may include conductive means (e.g., ports or pins) that allow direct communication with an external testing device. Test signals and data received through the direct access block 1112 may be transmitted to the core dies 1120 through 1150 via through-silicon vias (TSVs). For the testing of the core dies 1120 through 1150, data read from the core dies 1120 through 1150 may be transmitted to the testing device through the TSVs 1101 and the direct access block 1112. Accordingly, direct access testing for the core dies 1120 through 1150 can be performed.

The buffer die 1110 and the core dies 1120 through 1150 may be electrically connected to each other through TSVs 1101 and bumps 1102. The buffer die 1110 may receive signals provided to each channel from the SoC 1200 through the bumps 1102. For example, the bumps 1102 may be micro-bumps.

The SoC 1200 may execute applications supported by the semiconductor package 1000 using the stacked memory device 1100. For example, the SoC 1200 may include at least one processor among a CPU, an application processor (AP), a GPU, an NPU, a TPU, a vision processing unit (VPU), an image signal processor (ISP), and a digital signal processor (DSP) to perform specialized computations.

The SoC 1200 may include a physical layer 1210 and a memory controller 1220. The physical layer 1210 may include input/output circuits for transmitting signals to and receiving signals from the physical layer 1111 of the stacked memory device 1100. The SoC 1200 may provide various signals to the physical layer 1111 through the physical layer 1210. The signals provided to the physical layer 1111 may be delivered to the core dies 1120 through 1150 via the interface circuits of the physical layer 1111 and the TSVs 1101.

The memory controller 1220 may control the overall operation of the stacked memory device 1100. The memory controller 1220 may transmit signals for controlling the stacked memory device 1100 to the stacked memory device 1100 through the physical layer 1210. The memory controller 1220 may correspond to the memory controller 10 of FIG. 1 or FIG. 12.

The interposer 1300 may connect the stacked memory device 1100 and the SoC 1200. The interposer 1300 may connect the physical layer 1111 of the stacked memory device 1100 and the physical layer 1210 of the SoC 1200 and provide physical paths formed using conductive materials. Accordingly, the stacked memory device 1100 and the SoC 1200 may be stacked on the interposer 1300 and transmit/receive signals to/from each other.

Bumps 1103 may be attached to the upper side of the package substrate 1400, and solder balls 1104 may be attached to the lower side of the package substrate 1400. For example, the bumps 1103 may be flip-chip bumps. The interposer 1300 may be stacked on the package substrate 1400 through the bumps 1103. The semiconductor package 1000 may transmit signals to and receive signals from other external packages or semiconductor devices through the solder balls 1104. For example, the package substrate 1400 may be a printed circuit board (PCB).

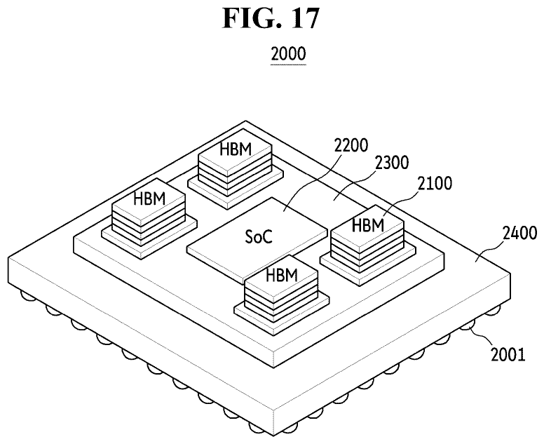

FIG. 17 is a diagram of a semiconductor package according to some example embodiments.

Referring to FIG. 17, a semiconductor package 2000 may include a plurality of stacked memory (“HBM”) devices 2100 and an SoC 2200. The stacked memory devices 2100 and the SoC 2200 may be stacked on an interposer 2300, and the interposer 2300 may be stacked on a package substrate 2400. The semiconductor package 2000 may transmit signals to and receive signals from other external packages or semiconductor devices through solder balls 2001 attached to the lower side of the package substrate 2400.

Each of the stacked memory devices 2100 may be implemented based on the HBM standard, but the present disclosure is not limited thereto. Alternatively, each of the stacked memory devices 2100 may be implemented based on the GDDR, HMC, or Wide I/O standard. Each of the stacked memory devices 2100 may correspond to the stacked memory device 1100 of FIG. 16.

The SoC 2200 may include at least one processor such as a CPU, AP, GPU, or NPU, and a plurality of memory controllers for controlling the stacked memory devices 2100. The SoC 2200 may transmit signals to and receive signals from the stacked memory devices 2100 through the respective memory controllers. The SoC 2200 may correspond to the SoC 1200 of FIG. 16.

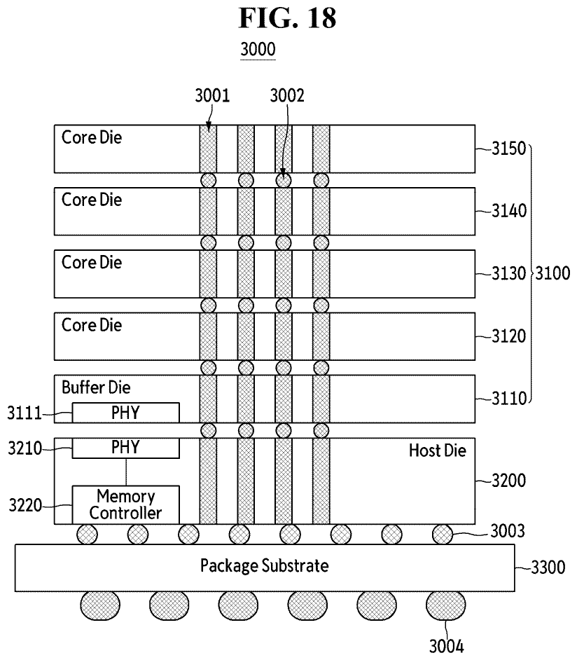

FIG. 18 is a diagram of a semiconductor package according to some example embodiments.

Referring to FIG. 18, a semiconductor package 3000 may include a stacked memory device 3100, a host device die 3200, and a package substrate 3300. The stacked memory device 3100 may include a buffer die 3110 and core dies 3120 through 3150. The buffer die 3110 may include a physical layer (“PHY”) 3111 for communication with the host device die 3200, and each of the core dies 3120 through 3150 may include a memory cell array.

The host device die 3200 may include a physical layer (“PHY”) 3210 for communication with the stacked memory device 3100 and a memory controller 3220 for controlling the overall operation of the stacked memory device 3100. In addition, the host device die 3200 may control the overall operation of the semiconductor package 3000 and include a processor for executing applications supported by the semiconductor package 3000. For example, the host device die 3200 may include at least one processor such as a CPU, AP, GPU, or NPU. The memory controller 3220 may correspond to the memory controller 10 of FIG. 1 or FIG. 12.

The stacked memory device 3100 may be vertically stacked on the host device die 3200 via TSVs 3001. Accordingly, the buffer die 3110, the core dies 3120 through 3150, and the host device die 3200 may be electrically connected to one another through the TSVs 3001 and bumps 3002 without an interposer. For example, the bumps 3002 may be micro-bumps. The stacked memory device 3100 may include the memory device 100 of any one of FIGS. 1 through 15.

Bumps 3003 may be attached to the upper side of the package substrate 3300, and solder balls 3004 may be attached to the lower side of the package substrate 3300. For example, the bumps 3003 may be flip-chip bumps. The host device die 3200 may be stacked on the package substrate 3300 through the bumps 3003. The semiconductor package 3000 may transmit signals to and receive signals from other external packages or semiconductor devices through the solder balls 3004.

Although embodiments of the present disclosure have been described with reference to the accompanying drawings, the present disclosure is not limited to the above embodiments, but may be implemented in various different forms. A person skilled in the art may appreciate that the present disclosure may be practiced in other concrete forms without changing the technical spirit or essential characteristics of the present disclosure. Therefore, it should be appreciated that the embodiments as described above is not restrictive but illustrative in all respects.

What is claimed is:

1. A memory device comprising:
a control logic circuit configured to receive a format conversion command that instructs conversion of first data having a first data type into second data having a second data type, and to generate format information based on the format conversion command; and
a format converter configured to receive the first data and generate the second data by converting the first data based on the format information,
wherein in response to the first and second data types being different, the format converter is further configured to:
clip the first data according to a clipping range determined based on the format information;
multiply the clipped first data by a scaling factor determined based on the format information; and
discard a fractional part of a result of the multiplication, and
wherein in response to the first and second data types being the same, the format converter is further configured to:
discard some bits of the first data according to the format information.

2. The memory device of claim 1, further comprising:
a memory cell array configured to store the first data,
wherein the control logic circuit is further configured to receive a read command for the first data that includes the format conversion command, and
wherein the format converter is further configured to output the second data.

3. The memory device of claim 1, further comprising:
a memory cell array,
wherein the control logic circuit is further configured to receive a write command for the first data that includes the format conversion command, and
wherein the format converter is further configured to store the second data in the memory cell array.

4. The memory device of claim 1, wherein the format conversion command specifies the clipping range for the first data.

5. The memory device of claim 4, wherein the format conversion command specifies a bit width of the second data.

6. The memory device of claim 4, wherein a bit width of the second data is pre-set within the control logic circuit.

7. The memory device of claim 1, further comprising:
a memory cell array configured to store multiple data,
wherein the control logic circuit includes a scrubbing circuit, and
wherein the scrubbing circuit is configured to determine the clipping range based on a value indicated by whichever of the multiple data indicates a largest value.

8. The memory device of claim 7, wherein the format conversion command specifies a bit width of the second data.

9. The memory device of claim 7, wherein a bit width of the second data is pre-set within the control logic circuit.

10. A memory system comprising:
a memory controller configured to receive a format conversion command that instructs the conversion of first data having a first data type into second data having a second data type, and to generate format information based on the format conversion command, the memory controller including a format converter configured to receive the first data and generate the second data by converting the first data based on the format information; and
a memory device,
wherein in response to the first and second data types being different, the format converter is further configured to:
clip the first data according to a clipping range determined based on the format information;
multiply the clipped first data by a scaling factor determined based on the format information;
discard a fractional part of a result of the multiplication; and
wherein in response to the first and second data types being the same, the format converter is further configured to:
discard some bits of the first data based on the format information.

11. The memory system of claim 10,
wherein the memory controller is further configured to receive a read command for the first data that includes the format conversion command, and
wherein the format converter is further configured to output the second data.

12. The memory system of claim 10,
wherein the memory controller is further configured to receive a write command for the first data that includes the format conversion command, and
wherein the format converter is further configured to store the second data in a memory cell array.

13. The memory system of claim 10, wherein the format conversion command specifies the clipping range for the first data.

14. The memory system of claim 13, wherein the format conversion command specifies a bit width of the second data.

15. The memory system of claim 13, wherein a bit width of the second data is pre-set within the memory controller.

16. The memory system of claim 10,
wherein the memory device includes a scrubbing circuit, and
wherein the scrubbing circuit is configured to determine the clipping range based on a value indicated by whichever of the multiple data stored in the memory device indicates a largest value, and provide the clipping range to the memory controller.

17. The memory system of claim 16, wherein the format conversion command specifies a bit width of the second data.

18. The memory system of claim 16, wherein a bit width of the second data is pre-set within the memory controller.

19. A data format conversion method comprising:
receiving, by a memory device, a format conversion command that instructs the conversion of first data having a first data type into second data having a second data type, which is different from the first data type;
generating, by the memory device, format information based on the format conversion command;
clipping, by the memory device, the first data according to a clipping range determined based on the format information;
multiplying, by the memory device, the clipped first data by a scaling factor determined based on the format information; and
discarding, by the memory device, a fractional part of a result of the multiplication based on the format information to generate the second data.

20. The data format conversion method of claim 19, further comprising:
determining, by the memory device, the clipping range based on a value indicated by whichever of multiple data stored in the memory device indicates a largest value.
